(19) United States
(12) Patent Application Publication
(10) Pub. No.: US 2014/0286506 A1
(43) Pub. Date: Sep. 25, 2014

(54) DIGITAL AUDIO MIXING DEVICE

(71) Applicant: Yamaha Corporation, Hamamatsu-shi (JP)

(72) Inventor: Shunichi KAMIYA, Hamamatsu-shi (JP)

(73) Assignee: Yamaha Corporation, Hamamatsu-shi (JP)

(21) Appl. No.: 14/225,225

(22) Filed: Mar. 25, 2014

(30) Foreign Application Priority Data
Mar. 25, 2013 (JP) 2013-062465
Mar. 25, 2013 (JP) 2013-062466

(51) Int. Cl. G10H 1/00

(52) U.S. Cl. CPC G10H 1/0033
USPC 381/119

(57) ABSTRACT

A mixer includes a plurality of input channels, a plurality of input groups, and a plurality of group strips that adjust values of parameters of the input groups. The mixer preliminarily prepares a plurality of group presets having data required for setup of group modules as presets, and each group preset has attribute information including musical genre, number of input channels, and instrument kind. By selecting a musical genre, a user can change the group presets which are being applied at present to the plurality of input groups to other group presets corresponding to another musical genre while keeping the number of input channels and the instrument kinds which are being used at present between before and after the change of genre.

### TECHNICAL FIELD

The invention relates to a digital audio mixing device, more specifically, to a technology for easily performing a setup work of an audio mixing device, including computer program or a computer readable storage medium storing a computer program.

### BACKGROUND ART

A digital audio mixing device (hereinafter, also simply referred to as a “mixer”) includes a plurality of channel strips (operating portion for one channel) and is configured such that one channel strip is used to adjust various parameter values for one channel (see, for example, NPL1).

At a site where a PA (Public Address) system including a mixer is used, such as a music concert hall or a conference hall, a constructor of a system performs a setup (initial setting) of the mixer. The setup work performed by the constructor of the system is as follows for instance. First, the constructor determines which microphone (input source) is to be assigned to each channel of the mixer, and performs physical connection of the microphones to microphone input terminals (input ports) and assignment (logical connection) of channels to the input ports. Then, the constructor adjusts parameter values for each channel using a channel strip corresponding to the channel.

For example, in the case of setting a plurality of microphones for a set of drums, the constructor of the system assigns a channel individually to each of the plurality of microphones and adjusts parameter values for each channel according to category, purpose or the like of the input source, such as setting for bass drums, setting for snare drums, setting for cymbals or the like.

In a conventional mixer, channels are individually assigned to a plurality of audio signals constituting a block with some meaning such as a plurality of audio signals relating to a set of drums respectively, and therefore correspondence between the plurality of audio signals in one block and a plurality of channel strips for controlling the channels to which the audio signals are assigned is hard to understand. Accordingly, the conventional mixer is inconvenient particularly to a user unfamiliar with operation of the mixer. Further, it is necessary to individually operate the plurality of channel strips so as to perform a setup work relating to the plurality of audio signals in one block, resulting in a lot of trouble with the setup work.

As a prior art relating to the above problems, there is a fader group function of gathering a plurality of channels to one fader group and collectively adjusting volumes of the plurality of channels (see PTL 1, PTL2 and NPL1). Further, PTL3 discloses a mixer including channel definition information defining a group for each channel as a technique for easily performing grouping. However, the conventional fader group function can only group a desired number of channels after completion of a setup work such as parameter adjustment for each channel, and it is necessary to perform the setup work itself channel by channel, resulting in a troublesome operation. Further, the conventional group function cannot perform appropriate grouping unless the user grasps correspondence between a plurality of input sources desired to be gathered into one group and channels to which the input sources are assigned. In addition, to fully use the fader group function, the user needs to be fully familiar with the operation method of the mixer and details of the function.

Furthermore, regarding simplification of the setup work, a “library function” and a “snap shot function” are conventionally provided. The “library function” is a function of preliminarily preparing, as preset data, values of a plurality of parameters in units of an arbitrary module such as equalizer, compressor, effector or one channel, assignment data between input ports and input channels and so on, and collectively setting a group of parameters using the preset data. The “snap shot function” is a function of preliminarily storing a setting (values of part or all of parameters) of a mixer as snap shot data, and calling the stored snap shot data to collectively set the setting of the mixer. The snap shot function includes a selective recall function of not calling a part of the stored snap shot data (for example, parameters of a part of modules), a recall safe function of excluding a part of parameters from target of the collective setting, and so on (see NPL1).

Use of the above-described library function or snap shot function may avoid adjustment for each channel in a setup work of a mixer. However, to fully use the snap shot function or the library function, the user needs to be familiar with data saved as the snap shot or the library, and it is not easy to realize a desired setup using the functions.

### CITATION LIST

### Patent Literature

{PTL1} JP 7-42219 U
{PTL2} JP 2004-253876 A
{PTL3} JP 2011-23839 A

### Non Patent Literature

{NPL1} “YAMAHA PM5D DIGITAL MIXING CONSOLE DSP5D DIGITAL MIXING SYSTEM PM5D/PM5D-RH V2 DSP5D OPERATION MANUAL” [online], Yamaha Corp., 2004, [retrieved on Dec. 29, 2012], Retrieved from the Internet <URL: http://www2.yamaha.co.jp/manual/pdf/pa/japan/mixers/pm5dv2_om_ja_h0.p df>

### SUMMARY OF INVENTION

### Technical Problem

The invention has been made in consideration of the above-described points, and its object is to realize easier setup operation in a digital audio mixing device.

### Solution to Problem

To attain the object, a digital audio mixing device of the invention is a digital audio mixing device including: a preset memory for storing a plurality of preset data, each of the plurality of the preset data including, as a preset, values of a plurality of parameters used in a signal processing module, each of the plurality of the preset data being corresponded to one kind of musical genre and including, as the preset, the values of the parameters suitable for the corresponded musical genre; a plurality of signal processing modules to be set up based on values of the plurality of the parameters included in the preset data being corresponded to a musical genre; a genre selector for selecting another musical genre other than presently selected musical genre according to an operation by a user; a changing device for changing, in response to the selection of the another musical genre, changing the preset data presently used to set up the signal processing modules to another preset data corresponded to the another musical genre, and setting up the signal processing modules based on values of the plurality of the parameters included in the another preset data.

In the above digital audio mixing device of the invention, since each of the preset data is corresponded to one kind of musical genre, a user can collectively change preset data corresponded to a kind of musical genre and presently used to set up a plurality of signal processing modules to other preset data corresponded to another kind of musical genre, only by providing instruction to select another musical genre, that is, to change the musical genre.

In such a digital audio mixing device, it is conceivable that each of the plurality of the preset data is corresponded to one kind of instrument, and the changing device executes the change of preset data in response to the selection of the another musical genre, if both the preset data presently used and the another preset data are corresponded to the same kind of instrument.

Since the preset data is corresponded to a kind of instrument, a user can collectively change preset data corresponded to a kind of musical genre and presently used to set up the plurality of signal processing modules to other preset data corresponded to another kind of musical genre but suitable for the kind of musical instrument which is presently applied.

Further, it is also conceivable that the signal processing modules include a channel module for processing an audio signal and a plurality of group modules, each of the group modules being for processing an audio signal of a group in which one or a plurality of the channel modules are gathered, each of the plurality of the preset data includes, as the preset, values of a plurality of group parameters used in the group module, and values of a plurality of channel module parameters used in one or a plurality of the channel modules to be grouped to the group module, and the changing device changes values of parameters used in the group module and values of parameters used in the one or the plurality of the channel modules grouped to the group module, to the values of the group parameters and the values of the channel module parameters included in the another preset data corresponded to the another musical genre.

Since the digital audio mixing device includes a plurality of group modules each of which processes an audio signal of a group in which one or a plurality of the channel modules are gathered, and is configured such that the preset data includes, as the preset, values of group parameters and values of a plurality of channel module parameters used in one or a plurality of the channel modules to be grouped, a user can collectively change values of a plurality of parameter used in a group module and values of a plurality of parameters used in one or a plurality of channel modules grouped to the group module to values included in another preset data corresponded to another musical genre.

Further, since a preset to be applied to signal processing modules can be changed based on musical genres, the above audio mixing device provides an advantageous effect such that setup operation can be performed quite easily.

Another digital audio mixing device of the invention is a digital audio mixing device including: a plurality of channel modules, each of the channel modules being for processing an audio signal; a plurality of group modules, each of the group modules being for processing an audio signal of a group in which one or a plurality of the channel modules are gathered; a plurality of group controllers, each of the group controllers corresponding to the group module and including plurality of controls for controlling the processing in the corresponding group module; a group preset memory for storing a plurality of group presets, each of the group presets including, as preset data, a channel module parameter value to be used in one or a plurality of the channel modules, a group module parameter value to be used in one of the group modules, and a grouping information for grouping the one or the plurality of the channel modules into the one group module; a group preset selector for selecting one of the group presets according to an operation by a user; and an application device for applying the selected group preset to one of the group modules, the application device setting up each of one or a plurality of the channel modules to be grouped based on the channel module parameter value of the selected group preset, setting up the one group module based on the group module parameter value of the selected group preset, and grouping the one or the plurality of the channel modules into the one group module.

Since the digital audio mixing device of the invention is configured such that a plurality of group modules, each of which processes an audio signal of a group in which one or a plurality of channels are gathered, and the processing in the group modules is controlled by the group controllers, group-by-group basis control can be realized using the group in which one or a plurality of channels are gathered. In such a configuration, since plural pieces of whole setup regarding a group module are stored as group presets, a user can perform whole setup regarding a group module including setting values of parameters of each of one or a plurality of the channel modules to be grouped, setting values of parameters of a group module, and grouping the one or the plurality of the channel modules, only by selecting an intended group preset.

Further, the above audio mixing device provides an advantageous effect such that setup operation of a group module in which a plurality of audio signals are gathered into one group, for example in player-by-player basis, can be performed quite easily.

### Advantageous Effects of Invention

A digital audio mixing device according to the invention can realize easier setup operation in a digital audio mixing device.

### BRIEF DESCRIPTION OF DRAWINGS

FIG. 1 is a block diagram explaining an outline of a configuration of signal processing modules of a digital audio mixing device according to an embodiment of the invention.

FIG. 2 is a view explaining an external appearance of the digital audio mixing device in FIG. 1 and a hierarchical structure of input groups.

FIG. 3 is a block diagram explaining an electrical hardware structure of the digital audio mixing device in FIG. 1.

FIG. 4 is a block diagram explaining a functional configuration of the digital audio mixing device in FIG. 1.

FIG. 5 is a block diagram explaining a detailed configuration example of an input channel module in FIG. 4.

FIG. 6 is a block diagram explaining a detailed configuration example of an input group module in FIG. 4.

FIG. 7 is a block diagram explaining a detailed configuration example of an output channel module in FIG. 4.

FIG. 8A is a view for explaining a data configuration of a group preset according to an embodiment of the invention.

FIG. 8B is another view for explaining the data configuration of the group preset.

FIG. 8C is still another view for explaining the data configuration of the group preset.

FIG. 9 is a chart illustrating an example of a screen for a user to select a group preset according to an embodiment of the invention.

FIG. 10 is a flowchart explaining group preset application processing according to an embodiment of the invention.

FIG. 11 is a flowchart explaining group preset change (update) processing according to an embodiment of the invention.

FIG. 12 is a diagram explaining an operation of setting effect information and Sub-bus use information.

FIG. 13 is a view illustrating an example of a screen for a user to instruct genre change of the group preset according to an embodiment of the invention.

FIG. 14 is a flowchart explaining group preset genre change processing according to an embodiment of the invention.

### DESCRIPTION OF EMBODIMENTS

Hereinafter, an embodiment of a digital audio mixing device of the invention will be described referring to the accompanying drawings.

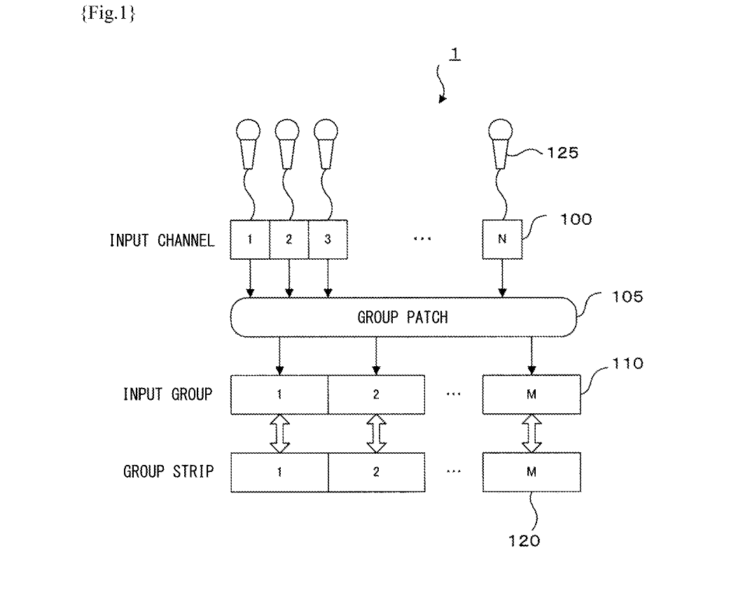

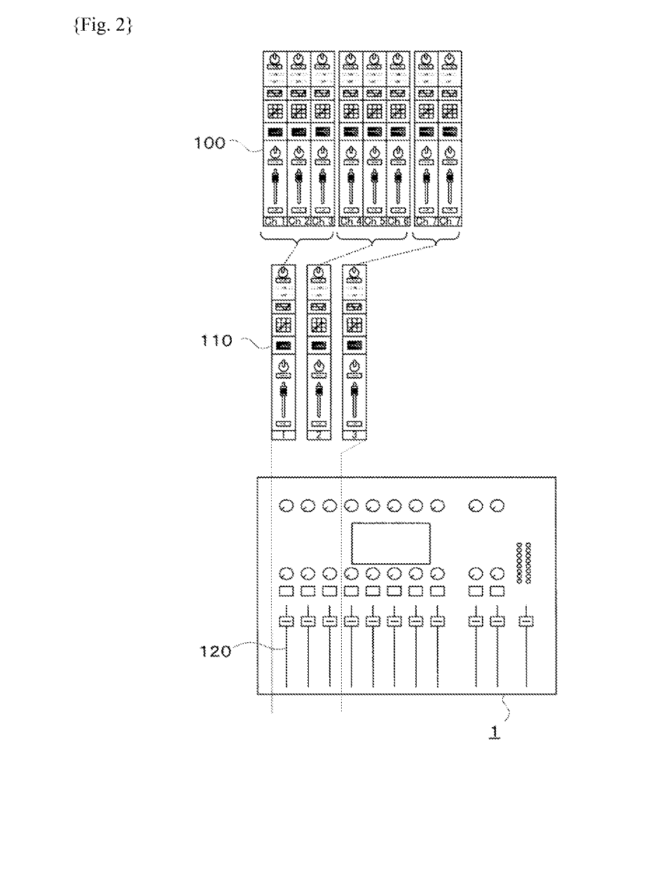

FIG. 1 is a block diagram explaining an outline of a configuration of a digital audio mixing device 1 (hereinafter, referred to as a “mixer”) according to an embodiment of the invention. FIG. 2 is a view explaining an external appearance of the mixer 1 and a hierarchical structure of input channels and input groups. Note that the “channel” is abbreviated to “ch”. Further, a “module” in this specification indicates a unit constituted by gathering components of the mixer 1 for each function.

As illustrated in FIG. 1, the mixer 1 includes a plurality of (N pieces of) input channels 100 and a group patch 105, a plurality of (M pieces of, note that M<N) input groups 110, and a plurality of (M pieces of) group strips 120. Each of the input channels 100 is a module that processes audio signals in one line (for one channel) inputted from an input source 125 such as a microphone. Each input channel 100 is connected (grouped) to one of the plurality of (M pieces of) input groups 110 via the group patch 105. Each of the input groups 110 is a module that processes output signals from one or a plurality of input channels 100 grouped via the group patch 105.

Each of the plurality of group strips 120 is a group operating portion provided on a console panel of the mixer 1 and has a plurality of physical controls including one fader control. To each of the plurality of group strips 120, one input group 110 is assigned as an operation target. In this embodiment, the plurality of M group strips 120 and the plurality of M input groups 110 shall be fixedly associated with each other on a one-to-one basis (see FIG. 1). Further, each input group 110 and each input strip 120 are managed by using a unique group number.

In FIG. 2, each input group 110 is expressed by a picture of an operating portion (group strip) for one module and a plurality of parameters included in the input group 110 are expressed by pictures of controls and display items. The user can adjust values of the parameters of the corresponding input group by using the respective controls in the group strip 120.

Each of one or plurality of the input channels 100 included in one input group 110 includes various parameters. In FIG. 2, one input channel 100 is expressed by a picture of operation portion (channel strip) for one channel and various parameters of one input channel are expressed by pictures of controls and display items in the operating portion. Basically, the various parameters of the input channel 100 are not operation targets of the group strip 120.

More specifically, the mixer 1 has, as a management unit, the input group 110 constituted by gathering one or a plurality of input channels, and can perform volume adjustment and adjustment of equalizing and so on for each input group 110 using the group strip 120. Also in each input channel 100, volume adjustment and processing of equalizing and so on are performed for each channel, but an operator (user) of the mixer 1 does not basically need to manually adjust parameters used for the processing in each channel.

In the example illustrated in FIG. 2, input channels 100 of “Ch1”, “Ch2”, and “Ch3” are grouped into an input group 110 with a group number “1”, and the input group 110 with the group number “1” is controlled by a group strip 120 associated with the group number “1”. Further, input channels 100 of “Ch4”, “Ch5”, and “Ch6” are grouped into an input group 110 with a group number “2,” and the input group 110 with the group number “2” is controlled by a group strip 120 associated with the group number “2”. Further, two input channels 100 of “Ch7” and “Ch8” are grouped into an input group 110 with a group number “3,” and the input group 110 with the group number “3” are controlled by a group strip 120 associated with the group number “3.”

The one or plurality of input channels 100 grouped into one input group 110 are a channel group constituting a block with some meaning (for example, for every instrument kind, for every player or the like), such as a plurality of input channels associated with a plurality of microphones installed for a set of drums. Therefore, as the way of using the mixer 1, control can be conducted instrument kind-by-kind basis or for player-by-player basis by each group strip 120 such that an input group of a drum set (drum player) is assigned to the first group strip 120 as its operation target, another input group of a guitar (guitar player) is assigned to the second group strip 120 as its operation target, and so on.

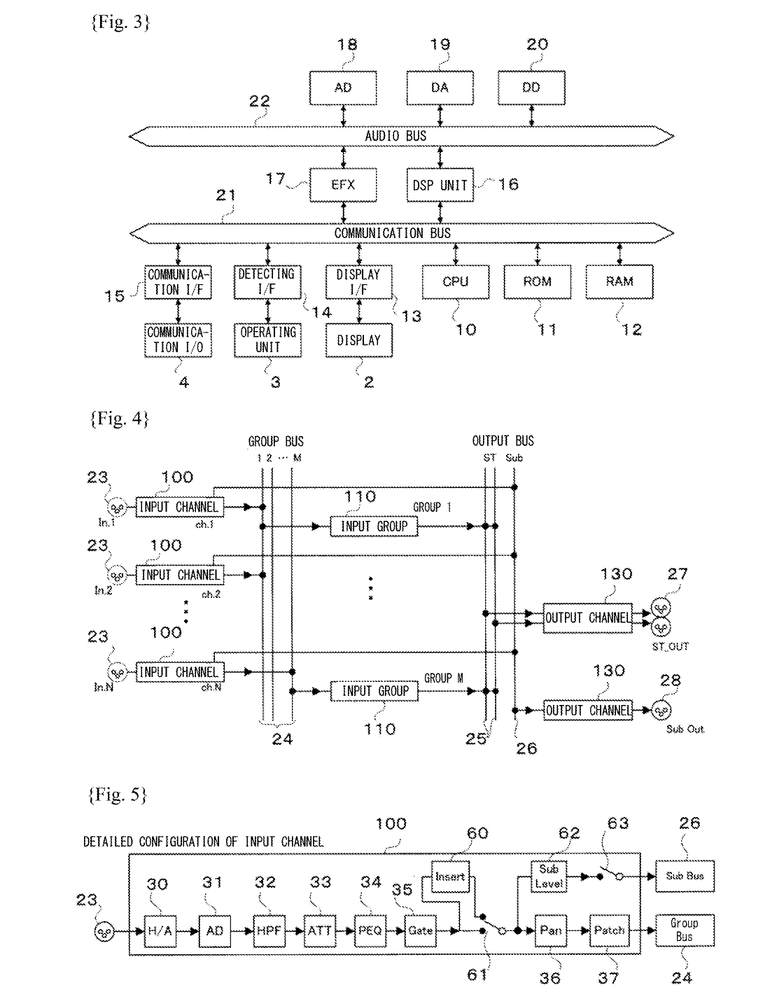

FIG. 3 is a block diagram illustrating a hardware structure of the mixer 1. The mixer 1 includes a central processing unit (CPU) 10, a read-only memory (ROM) 11, a random access memory (RAM) 12, a display interface 13 (display I/F), an operation detecting interface 14 (detecting I/F), a communication interface 15 (communication I/F), a signal processor 16 (DSP unit), an effect processor 17 (EFX), an analog-digital converter (AD) 18, a digital-analog converter (DA) 19, and a digital-digital converter (DD) 20.

The CPU 10, the ROM 11, the RAM 12, the display I/F 13, the detecting I/F 14, the communication I/F 15, the DSP unit 16, and the EFX 17 are connected via a communication bus 21 so that various control signals can be communicated between the CPU 10 and the units 11 to 17. Further, the DSP unit 16, the EFX 17, the AD converter 18, the DA converter 19, and the DD converter 20 are connected to one another via a audio bus 22 so that digital audio signals can be communicated among the units 16 to 20.

The CPU 10 executes various programs stored in the ROM 11 or the RAM 12 to control operation of the whole mixer 1. The ROM 11 is a non-volatile memory that stores the various programs executed by the CPU 10 and various kinds of data. The RAM 12 is used as a load area and work area for the programs executed by the CPU 10, and includes a current memory that stores present values of all parameters relating to processing of the mixer 1.

A display 2 is connected to the display I/F 13. The display 2 displays various kinds of information based on display control signals supplied from the CPU 10, by various images, character strings and the like. An operating unit 3 is connected to the detecting I/F 14. The operating unit 3 is a group of controls arranged on a console panel including the group strips 120. The CPU 10 acquires a detection signal according to an operation event at the operating unit 3 by the user, changes values of the various parameters stored in the current memory, and reflects change results in the signal processing operations of the DSP unit 16 and the EFX 17, and display on the display 2.

A communication input/output unit (communication I/O) 4 is connected to the communication I/F 15. The communication I/O 4 is a general-purpose interface such as a USB (Universal Serial Bus) terminal or the like for connecting with other peripheral devices, and a peripheral device (for example, a computer for remotely controlling the mixer 1 or the like) is connected to the communication I/O 4.

The AD converter 18 includes a plurality of input ports, and converts analog audio signals inputted from the input ports into digital audio signals, and then supplies the digital audio signals to the audio bus 22. The DA converter 19 includes a plurality of output ports, and converts digital audio signals supplied from the audio bus 22 into analog audio signals, and then supplies the analog audio signals to the output ports. The DD converter 20 includes a plurality of digital input/output ports and a digital converter (format converter), and inputs/outputs one or a plurality of digital audio signals between an external device and the mixer 1.

Each of the DSP unit 16 and the EFX 17 may be composed of one DSP (Digital Signal Processor) or a plurality of DSPs mutually connected via a bus to perform distributed signal processing in the plurality of DSPs. The DSP unit 16 executes a microprogram based on instructions by the CPU 10 and thereby performs digital signal processing on one or a plurality of audio signals supplied from the audio bus 22 and outputs the resultant signals to the audio bus 22. The digital signal processing executed by the DSP unit 16 is routing of audio signals, adjustment of sound characteristics (sound volume level and sound quality), mixing processing of mixing a plurality of audio signals, and so on. The EFX 17 is a DSP for effect processing (effect application) on audio signals, and performs effect application processing on audio signals supplied from the audio bus 22 and outputs the resultant signals to the audio bus 22 based on instructions by the CPU 10.

FIG. 4 is a block diagram illustrating a functional configuration of the mixer 1. Operation of each module in FIG. 4 is entirely realized by digital signal processing by the DSP unit 16 and the EFX 17. Input ports 23 (“In.1” to “In.N”) are input terminals included in the AD converter 18, and each of them receives input of audio signals from an audio signal source (one microphone or the like) of one line. Each of the plurality of N input channels (modules) 100 is associated with one input port 23.

Each input channel 100 processes the audio signal inputted into one corresponding input port 23 according to present values of the various parameters for the input channel. Output signals from the input channel 100 are supplied to one of M pieces of group buses 24 via the group patch (numeral 105 in FIG. 1).

The M pieces of group buses 24 are associated with the M groups 110 at the subsequent stages on a one-to-one basis. Each group bus 24 mixes output signals from one or a plurality of input channels 100 connected thereto via the group patch (numeral 105 in FIG. 1) and outputs the resultant signal to one corresponding input group 110. In other words, connecting one or a plurality of input channels 100 to one group bus 24 realizes assignment (grouping) of the one or a plurality of input channels 100 to the input group 110 corresponding to the group bus 24.

The input group 110 processes the audio signals supplied from the corresponding group bus 24 according to values of the various parameters for the input group. Output signals from the input group 110 are supplied to an output channel (module) 130 via a stereo output bus (ST) 25, processed in the output channel 130, and then outputted from a stereo output port 27.

The mixer 1 further includes a sub-bus 26 as one output bus, and thereby can supply the output signals from the input channel 100 to the sub-bus (Sub) 26. The audio signals from the sub-bus 26 are processed at the output channel 130 and outputted from a sub-bus output port 28.

FIG. 5 to FIG. 7 illustrate detailed configuration examples of the input channel 100, the input group 110, and the output channel 130. As illustrated in FIG. 5 to FIG. 7, each of the input channel 100, the input group 110, and the output channel 130 includes a plurality of control modules. Each of the control modules is a module having a specific function relating to adjustment of the sound characteristics (for example, sound volume level and sound quality).

In FIG. 5, the input channel 100 includes, for example, a head amplifier (H/A) 30, an AD converter (AD) 31, a high-pass filter (HPF) 32, an attenuator (ATT) 33, a parametric equalizer (PEQ) 34, a gate (Gate) 35, a pan (Pan) 36, and a group patch (Patch) 37. The group patch 37 corresponds to the group patch 105 in FIG. 1, and connects the output of the input channel 100 to one of the M pieces of group buses 24 based on later-described “assignment information”. Other control modules 30 to 36 perform processing corresponding to the respective functions. Note that the operations of the H/A 30 and the AD converter 31 are performed by the AD converter 18 in FIG. 3. Values of various parameters controlling the modules 30 to 37 included in the input channel 100 are basically not called on the group strip 120 on the console panel and not subjected to manual adjustment by the user.

The input channel 100 further includes an insertion effector (Insert) 60 and a switch 61 that switches between ON and OFF of the insertion effector 60, and is configured such that when the switch 61 is ON, effect by the insertion effector 60 is applied to the audio signals in the input channel 100. The input channel 100 further includes a sub-bus level (Sub Level) 62 that adjusts an output level to the sub-bus 26 and a switch 63 that switches between ON and OFF of output to the sub-bus 26.

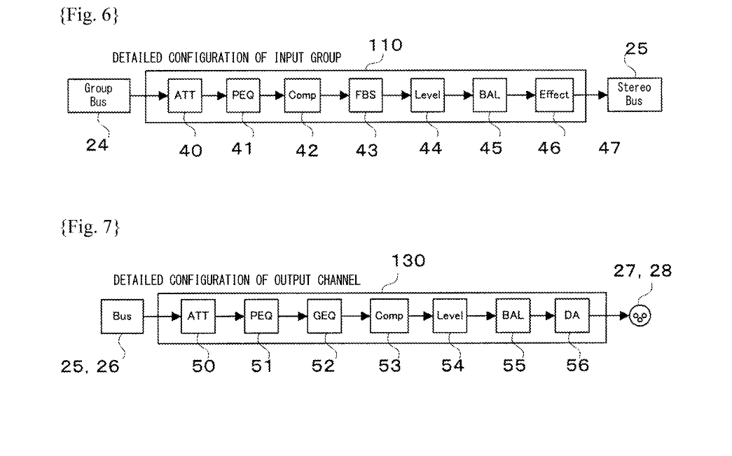

In FIG. 6, the input group 110 includes, for example, an attenuator 40, a parametric equalizer 41, a compressor (Comp.) 42, a howl suppression function (FBS, feedback suppression) 43, a level control (Level) 44, a balance control (BAL) 45, and an effector (Effect) 46. The user can adjust values of various parameters controlling the modules 40 to 46 included in the input group 110 using the group strip 120 on the console panel.

In FIG. 7, the output channel module 130 includes, for example, an attenuator 50, a parametric equalizer 51, a graphical equalizer (GEQ) 52, a compressor 53, a level control 54, a balance control 55, and a DD converter 56. Values of various parameters of the modules 50 to 56 included in the output channel module 130 may be adjustable by using a channel strip for the output channel on the console panel.

Next, “group preset” will be described. The group preset is data composed of values of all parameters required for setup relating to one input group 110, which is stored as a preset. In the memory (ROM 11 or RAM 12) of the mixer 1, a plurality of group presets are stored.

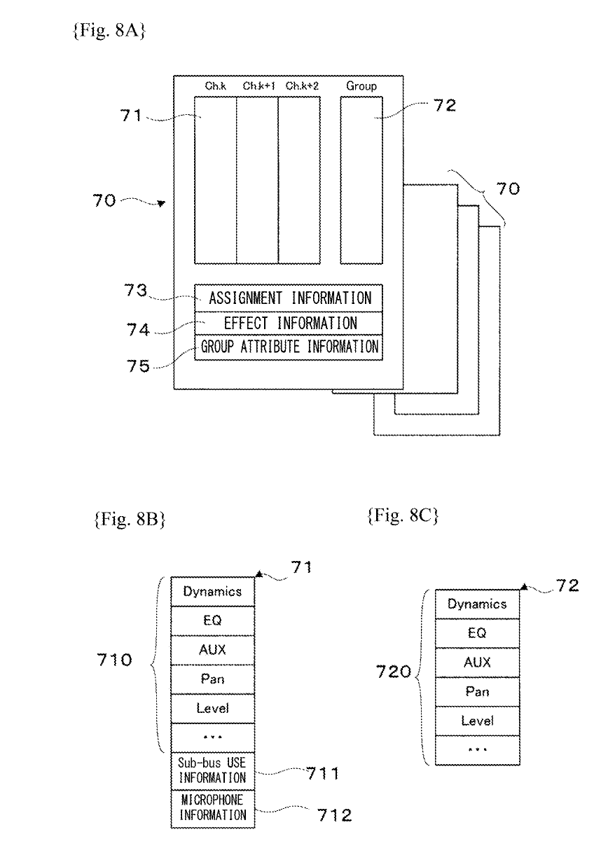

FIGS. 8A to 8C are views for explaining a data configuration example of the group preset. As illustrated in FIG. 8A, one group preset 70 includes one or a plurality of input channel parameter sets 71, an input group parameter set 72, assignment information 73, effect information 74, and group attribute information 75. Each of the group presets 70 corresponds to a preset for one group.

The number of input channel parameter sets 71 included in one group preset 70 corresponds to the number of input channels included (to be grouped) in the group. As described above, one or a plurality of input channels included in one group only need to be a plurality of input channels constituting a block with some meaning, such as instrument kind-by-kind basis, player-by-player basis or the like. Accordingly, the number of input channel parameter sets 71 included in each of the plurality of group presets 70 are unfixed.

In each of the input channel parameter sets 71 in one group preset 70, a relative channel number in the group may be set. In the example of the drawing, channel numbers “ch.k”, “ch.k+1”, and “ch.k+2” are applied to three input channel parameter sets 71 so that order of the input channel parameter sets 71 in the group can be identified.

One input channel parameter set 71 includes an input channel parameter value 710 including values of all parameters used in one input channel 100, such as “Dynamics”, “EQ”, “AUX”, “PAN”, and “Level”, Sub-bus use information 711, and microphone information 712 as illustrated in FIG. 8B. Further, each of the input channel parameter sets 71 may include attribute information indicating name and so on of the input channel.

Values of the various parameters included in each input channel parameter value 710 take, as presets, values suitable for the usage, roll and the like intended for the input channel. For example, if there is a group preset 70 including three input channels (channel for bass drum, channel for snare drum, channel for cymbals) for drums (drum player), the three input channel parameter sets 71 included in the group preset 70 take, as presets, various parameter values suitable for the bass drum, various parameter values suitable for the snare drum, and various parameter values suitable for the cymbals as input channel parameter values 710, respectively.

The Sub-bus use information 711 includes value of the sub-bus level 62 of the input channel, and setting of ON/OFF (switch 63) of the output to the sub-bus. The microphone information 712 is information specifying a microphone to be used for the input channel and, for example, information specifying the manufacturer and the model name of the microphone. The microphone is different in characteristics according to the manufacturer and the model, and it is therefore conceivable to prepare presets in consideration of the characteristics of the microphone to be used as the input channel parameter value 710 of each input channel parameter set 71. In this case, manufacturer, model and so on of a microphone suitable for the input channel parameter value 710 (setting in consideration of characteristics of a specific microphone) of the input channel parameter set 71 can be instructed based on the microphone information 712.

The input group parameter set 72 has an input group parameter value 720 including all parameter values used in one input group 110 (see FIG. 6), such as “Dynamics”, “EQ”, “AUX”, “PAN”, and “Level” as illustrated in FIG. 8C. In the input group parameter value 720, values suitable for the category, purpose, usage and so on of the input group are stored as presets.

The assignment information 73 is grouping information for grouping (assigning) one or a plurality of input channels 100 to be grouped to one input group 110. More specifically, the assignment information 73 is information for controlling the group patch 37 of the input channel 100 so as to connect the output of the input channel 100 to one group bus 24 corresponding to the input group 110 that will be an application destination of the group preset 70. Operation of the group patch 37 for one channel based on the assignment information 73 is, for example, turning on only the output to the group bus 24 corresponding to the application destination among the M pieces of group buses 24 and turning off the output to the other group buses 24.

The effect information 74 is information relating to use of the effector in each of the input channels 100 included in one group and/or input group 110. For example, it is conceivable to have, as the effect information 74, information on collective setting of ON/OFF of effect insertion (switches 61) to all of the input channels 100 included in one group, collective setting of kinds of the insertion effectors 60 and parameter values thereof, or setting of kind of the effector used in the input group 110 and parameter values thereof.

The attribute information 75 includes, for example, name, category, number of input channels, genre, evaluation, use frequency and so on. The name is the name of the group preset. Each of the plurality of group presets 70 has a unique name. The category is a class indicating kind and usage of an instrument, such as drum, guitar, bass, vocal, MC (master of ceremony) or the like. The number of input channels indicates the number of input channels included in the group preset. The genre is a class indicating a musical genre or use scene suitable for the group preset, such as rock, jazz, pop, conference or the like. The evaluation indicates evaluation given by a user to the group preset. The use frequency is the number of times of the group preset used. The attribute information 75 makes it possible to group the plurality of group presets 70 according to the attribute information 75 (for example, category, number of input channels, genre or the like).

The mixer 1 is preliminarily prepared with, as the group presets 70, a plurality of group presets 70 according to instrument kinds, usages, numbers of input channels, and musical genres, such as a group preset including three input channels for drums, a group preset including two input channels for guitars, and a group preset including eight input channels for conference. Only by selecting, from among the plurality of group presets 70, a desired group preset according a condition such as instrument kind, usage, musical genre, or number of input channels and applying the selected group preset to the input group 110, a user can make setup relating to the input group 110 suitable for the condition.

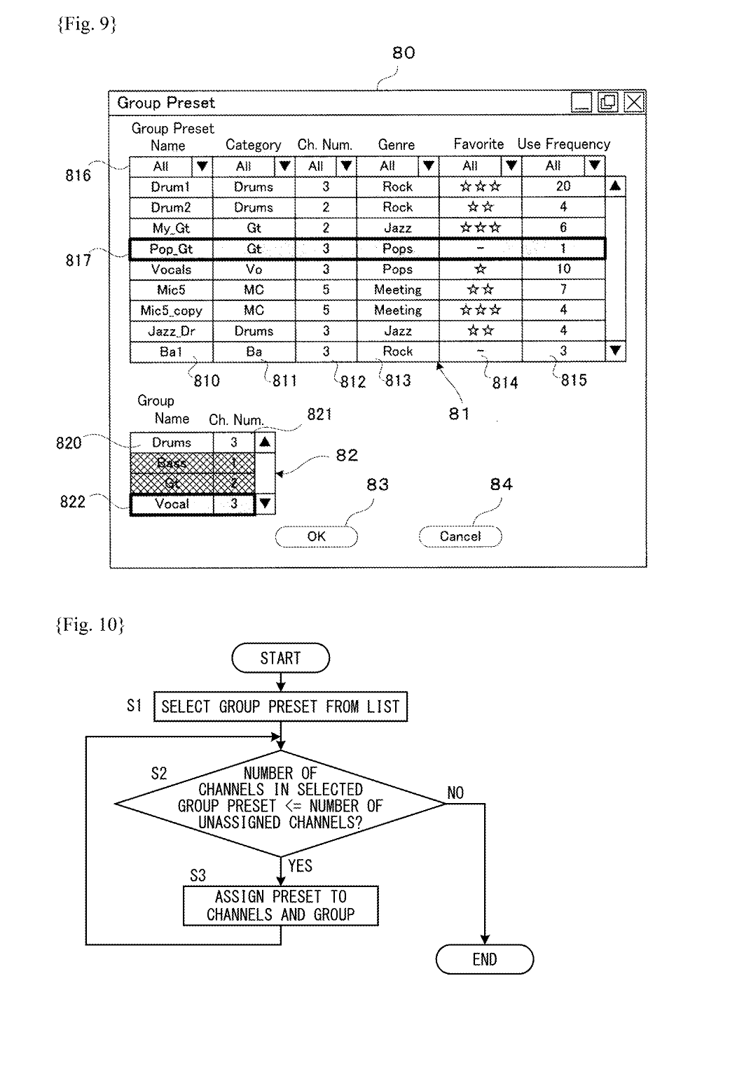

FIG. 9 illustrates a group preset application screen 80 as an example of a user interface for applying (assigning) the group preset 70 to the input group 110. The CPU 10 displays the group preset application screen 80 on the display 2, for example, in response to an operation by the user. The group preset application screen 80 includes, as illustrated in FIG. 9, a group preset selection section 81 and a group display section 82.

The group preset selection section 81 is a list that displays the plurality of group presets 70 (see FIG. 8) stored in the memory (ROM 11 or RAM 12) and displays the attribute information of one group preset 70 on each row. The attribute information displayed on each row is, for example, a name 810, a category 811, a number of channels 812, a genre 813, evaluation (“favorite”) 814, and a use frequency 815. The CPU 10 can display the attribute information on each group preset 70 based on the group attribute information 75. In each of columns 810 to 815, a character string, numeral or the like indicating the relevant attribute information is displayed. Regarding the evaluation 814, a level of evaluation is displayed with the number of “stars.”

In the group preset selection section 81, a filter condition specification section 816 is provided. The filter condition specification section 816 is configured such that the user can specify a condition for each item of the attribute information (name, category, number of channels, genre, evaluation, and use frequency) 810 to 815 of the group preset 70, so that a group presets displayed in the group preset selection section 81 can be filtered (narrowed down) according to the specified filter condition. For example, by specifying “Drums” as the filter condition of the category, only group presets 70 corresponding to the category of “Drums” are displayed in the group preset selection section 81. In the example illustrated in FIG. 8, “All” is specified as each of filter conditions for all of the items of the attribute information and, in this case, the group preset selection section 81 displays all group presets 70.

The group display section 82 is a section that displays a list of information on input groups 110 to which the group presets are applied at present among the plurality of the input groups 110 included in the mixer 1. Each row of the group display section 82 displays a name 820 of the group preset which is being applied to the corresponding input group 110, and a number 821 of input channels included in the group preset. Display order of the input groups in the group display section 82 is preferably, for example, in a group number order.

By putting a cursor 817 using the control 3 at a desired row in the group preset selection section 81, the user can select a group preset corresponding to the row. Further, by putting a cursor 822 at a desired row in the group display section 82, the user can select an input group 110 corresponding to the row. The selection of the group preset is determined by pressing an OK button.

In this embodiment, if only selection of a group preset is performed in the group preset selection section 81, the selected group preset is applied to an input group 110 (unassigned group) to which no group preset has not been applied among the plurality of (M pieces of) input groups 110 included in the mixer 1.

FIG. 10 is a flowchart of processing of applying a group preset to an unassigned group. The CPU 10 activates the processing in FIG. 10 when only the selection of a group preset is performed in the group preset application screen 80. At step S1, the CPU 10 identifies the one group preset selected by a user in the group preset selection section 81, and reads the identified one group preset 70 from the memory (ROM 11 or RAM 12) storing the group presets.

At step S2, the CPU 10 compares the number of input channels included in the selected group preset 70 and the number of input channels (unassigned channels) which have not been grouped to any input group 110 among all of the input channels 100 included in the mixer 1. If the number of unassigned channels is larger than or equal to the number of channels included in the selected group preset 70 (YES at step S2), the CPU 10 secures a required number of input channels 100 from the unassigned channels and applies the selected group preset 70 to the secured one or plurality of input channels 100 at step S3. Note that determination of the input group 110 being the application destination can be performed according to a predetermined rule, such as an ascending order of the group number. Further, securement of the unassigned channels is performed according to a predetermined rule, such as an ascending order of the channel number.

By the step S3, the whole setup (initial setting) relating to one input group 110 can be performed on the basis of the selected group preset 70. The detail of the setup is as follows for instance. (1) Current data of all parameters of the secured one or plurality of input channels 100 is set up based on one or a plurality of input channel parameter sets 71 included in the group preset 70 are set. (2) The outputs of the secured one or plurality of input channels 100 are connected to the one input group 110 being the application destination of the group preset 70 based on the assignment information 73 included in the group preset 70. (3) Current data of all parameters of the one input group 110 being the application destination is set up based on the input group parameter set 72 included in the group preset 70. (4) Name of the input group 110 being the application destination is set to the name of the group included in the attribute information 75. (5) The setting relating to use of the effect in the grouped one or plurality of input channels 100 is performed based on the effect information 74. (6) Each of the grouped input channels 100 are set up based on the microphone information 712 and the Sub-bus use information 711. (7) Further, if the attribute information indicating the name and so on of the input channel is included in each input channel parameter set 71, channel name of each of the grouped input channels 100 is set based on the attribute information.

On the other hand, if the number of unassigned channels is smaller than the number of channels included in the selected group preset (NO at step S2), the CPU 10 ends the processing without applying the group preset.

At the time when a group preset is applied to a new input group 110 though the processing in FIG. 10, the CPU 10 adds the information on the input group 110 to the group display section 82.

By selecting one group preset in the group preset selection section 81 and selecting one input group 110 in the group display section 82, the user can change the group preset which is being applied to the input group 110 selected in the group display section 82 to the group preset newly selected in the group preset selection section 81.

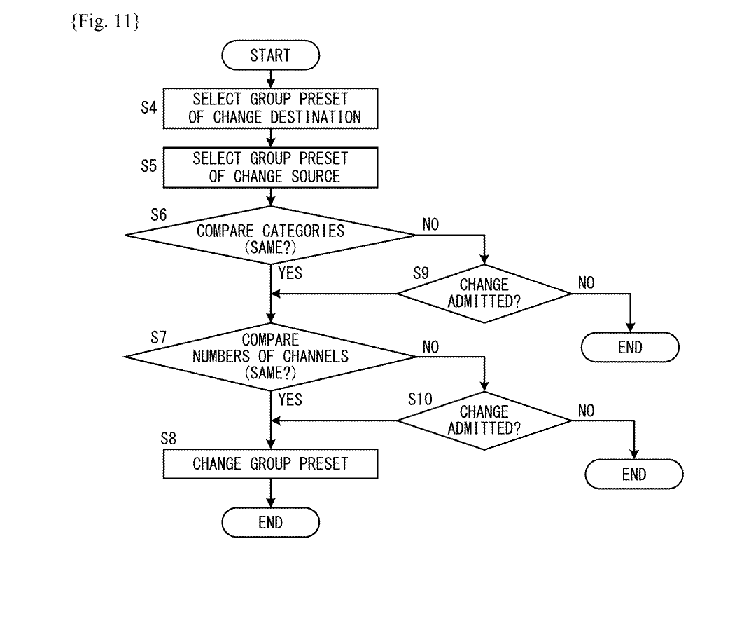

FIG. 11 is a flowchart of processing of changing (updating) the group preset which is being applied to the input group 110. At step S4, the CPU 10 identifies a group preset (group preset that is a change destination) selected in the group preset selection section 81.

In this event, the CPU 10 displays only input groups 110 to which the identified group preset 70 being the change destination is applicable in a normal display state and displays the other input groups 110 in grayout, in the group display section 82. The “input group to which the identified group preset 70 being the change destination is applicable” means an input group having a group preset 70 applied thereto at preset (group preset being the change source) which has an attribute in common with a group preset 70 being the change destination and to (over) which the group preset 70 being the change destination can be applied (written) as it is without changing the attribute such as the number of channels, category and so on. In the example of FIG. 9, since a group preset “Pop_Gt” with a number of channels of “3” is selected in the group preset selection section 81, only the input groups with a number of channels of “3” (the uppermost “Drums” and the lowermost “Vocal”) are normally displayed and the input groups with different numbers of channels (the second from the top “Bass” and the third “Gt”) are displayed in grayout in the group display section 82.

The user selects one input group 110 from the group display section 82 as an application destination and presses the OK button 83 to determine the selection. The CPU 10 identifies the input group 110 selected in the group display section 82 and identifies the group preset 70 which is being applied to the identified input group 110 (the group preset being the change source) at step S5.

At step S6, the CPU 10 compares the categories included in the respective pieces of attribute information 75 of the group preset being the change destination identified at the step S4 and the group preset being the change source identified at the step S5. At step S7, the CPU 10 further compares the numbers of channels included in the respective pieces of attribute information 75 of the group preset being the change destination identified at the step S4 and the group preset being the change source identified at the step S5. Note that the order of the steps S6, S7 is not limited to that in the illustrated example, but the numbers of channels may be compared first and the categories may be compared next.

If the group preset being the change destination and the group preset being the change source coincide in the category and the number of channels (YES at steps S6, S7), the CPU 10 changes the group preset being the change source to the group preset being the change destination at step S8. In other words, the group preset selected in the group preset selection section 81 is applied to the input group 110 selected in the group display section 82. Thus, based on the selected group preset 70, all setups relating to the selected input group 110 (including setting of values of parameters of each input channel 100 and values of parameters of the input group 110, and setting relating to use of effect of the input channel 100) are collectively changed. Note that since there is no change in the number of input channels in this case, setting of the group path 37 of each input channel 100 does not need to be changed.

On the other hand, if the group preset being the change destination and the group preset being the change source do not coincide in the category and/or the number of channels (NO at steps S6 and/or S7), the CPU 10 displays a “confirmation dialog” window on the display 2 and thereby confirms with the user that the attribute will be changed (steps S9 and/or S10). The user makes a response of either admitting the change to the displayed confirmation dialog (presses the OK button 83) or not admitting the change (presses a cancel button 84). If the user does not admit the change to the attribute (NO at steps S9 and/or S10), the CPU 10 ends the processing without updating the group preset.

If the user admits the change (YES at steps S9 and/or S10), the CPU 10 changes the group preset being the change source to the group preset being the change destination at the step S8. Note that when the number of channels is changed, setting of the group patch 37 of each input channel 100 (setting of grouping the input channels) is changed based on the group preset being the change destination at the step S8. When the number of channels will be increased, the unassigned input channel securing processing which is described above using FIG. 10 is performed to newly secure input channels. When unassigned input channels cannot be secured, change of the group preset is not performed.

By the step S8, the user can collectively change all setups relating to one input group 110 with ease only by selecting desired group preset 70 and input group 110.

In other words, the step S3 or the step S8 corresponds to operation of an application device, which allows the user to perform all setups required for one input group 110 only by selecting a desired group preset 70. For example, once the user selects a group preset for drums with a number of input channels of “3,” input channel parameter values suitable for the secured three input channels 100 (for example, various parameter values suitable for bass drums, various parameter values suitable for snare drums, and various parameter values suitable for cymbals) are set in the respective channels, and group parameter values suitable for drums are set in the input group 110 being the application destination, and setting for connecting (grouping) the three input channels to the input group 110 being the application destination is also completed.

Since a group preset 70 constituted by gathering parameter values for one or a plurality of input channels 100 is prepared according to instrument kind or usage, even a user being unfamiliar with the operation of the mixer easily understands correspondence between the input group 110 being the application destination (group strip 120) and the instrument kind (player) or usage being a control target. For example, the user can perform, by an intuitively understandable simple operation, setup for grouping a plurality of input channels in instrument kind-by-kind basis (player-by-player basis) or usage-by-usage basis, such as assigning, as operation targets of respective group strips, “drum” for three channels to the first group strip, “bass” for three channels to the second group strip, vocal for two channels to the third group strip, and so on.

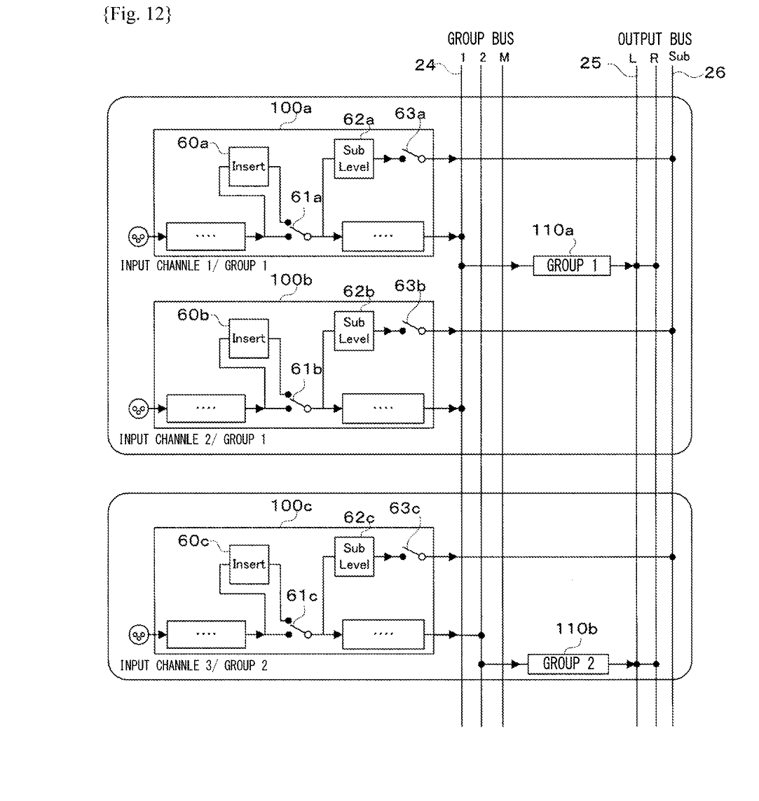

By the step S3 or S8, in the case where information relating to use of effect is set in the effect information 74 at the time when applying a group preset 70 to the input group 110, information relating to use of the effector in each of the input channels 100 in one group and/or input group 110 is collectively set in group-by-group basis. The operation of setting the information relating to use of the insertion effector 60 based on the effect information 74 will be described referring to FIG. 12.

FIG. 12 is a block diagram illustrating the input channels 100, the group buses 24, the input groups 110, the stereo output buses 25, and the sub-bus 26 which are illustrated in and extracted from FIG. 4. In FIG. 12, an input channel 100a of “ch1” and an input channel 100b of “ch2” are connected to the first group bus 24 and thus grouped into an input group 110a with a group number “1.” An input channel 100c of “ch3” is connected to the second group bus 24 and thus grouped into an input group 110b with a group number “2”.

For example, in the case where information of switching ON/OFF of the insertion effector 60 is included in a group preset 70 as the effect information 74 and the group preset 70 is applied to the group number “1”, an insertion effector switch 61a of the input channel 100a and an insertion effector switch 61b of the input channel 100b included in the group can be collectively switched. Since one piece of effect information 74 is included in one group preset 70, information relating to use of the insertion effectors 60 in a plurality of input channels included in one group can be collectively set based on the effect information 74.

In contrast, the Sub-bus use information 711 included in one group preset 70 is prepared for each of the plurality of input channel parameter sets 71 included in the group preset, so that setting relating to the sub-bus 26 in each of the input channels 100 included in one group is performed for each input channel 100. For example, for a sub-bus switch 63a of the input channel 100a and a sub-bus switch 63b of the input channel 100b included in the input group 110a with the group number “1,” values of the sub-bus levels 62 and ON/OFF settings of the switches 63 are set based on different pieces of Sub-bus use information 711 respectively.

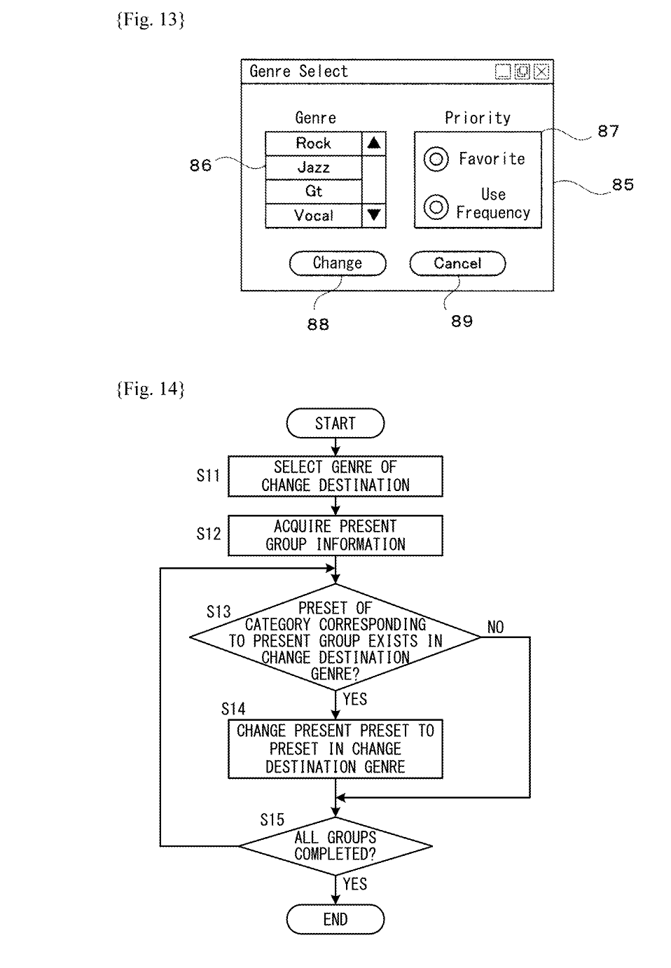

Next, as an embodiment of a group preset changing method, a method of collectively switching group presets applied to a plurality of input groups 110 according to selection of genre will be described. FIG. 13 illustrates an example of a user interface (a genre change screen 85) for selecting a genre. The CPU 10 displays the genre change screen 85 on the display 2 in response to operation by a user. In a genre selection section 86, names of selectable genres, such as “rock,” “jazz,” and so on are displayed in a list. The “selectable genres” are all genres prepared, for example, as genres of the group presets 70. A priority order setting section 87 displays radio buttons for selecting any of evaluation (“favorite”) and use frequency so as to enable to set a priority order to the attribute information (evaluation and use frequency in the example of the drawing) of the group preset.

By selecting one desired genre in the genre selection section 86 and pressing a change button 88, the user can collectively change the group presets which are being applied to the plurality of input groups 110 to the group presets belonging to the genre selected in the genre selection section 86.

FIG. 14 is a flowchart of group preset genre change processing. The CPU 10 identifies a genre being a change destination selected in the genre selection section 86 at step S11, and acquires information on group presets 70 which are being applied to any of the input groups 110 at present at step S12. The information to be acquired includes, for example, information identifying each input group 110 which is being used at present (to which a group preset is being applied) and category of the group presets which are being applied to any of the input groups 110.

At step S13, the CPU 10 investigates, for one of the input groups 110 which are being used at present as a processing target, whether a group preset 70 corresponding to the category of the group preset which is being applied to the input group 110 exists in the genre being the change destination identified at the step S11.

If some group preset 70 corresponding to the category exists in the genre being the change destination (YES at step S13), the CPU 10 changes the group preset which is being applied to the input group 110 being a processing target to the group preset 70 corresponding to the category in the genre being the change destination at step S14. The group preset change itself is the same processing as that at the steps S3 and S8. Here, when one of a plurality of group presets should be determined such as the time when a plurality of group presets in the same category exist in the genre being the change destination, the one group preset is determined based on the attribute (evaluation or use frequency) selected as attribute information with a high priority order in the priority order setting section 87. For example, when the evaluation (“favorite”) is selected in the priority order setting section 87, a group preset 70 with the highest evaluation among the plurality of group presets is determined as the change destination. If the group preset being the change source and the group preset 70 being the change destination are different in number of input channels, processing of securing and grouping a required number of input channels is also performed. Note that if the required number of input channels cannot be secured, the CPU 10 proceeds to step S15 without updating the group preset relating to the input group 110 being the processing target.

Then, until the processing for all of the input groups 110 which are being used at preset is completed, the CPU 10 loops the steps S13 and S14 (NO at step S15). Upon completing the processing for all of the input groups 110 which are being used at preset (YES at step S15), the CPU 10 ends the processing. By the steps S13 to S15, genre of the group preset to be applied to a plurality of input groups 110 can be collectively switched to collectively change values of all parameters (input channel parameters of each input channel, input group parameters of each input group 110) relating to the plurality of input groups 110 according to group presets corresponding to the newly selected genre.

According to this embodiment, only by switching the genre, it is possible to collectively change values of the various parameters (preset values) respectively set in the plurality of input groups 110 of the mixer 1 to preset values suitable for another genre that is different from the genre which is being applied at present while keeping the number of input channels and the instrument kinds which are being used at present between before and after the change of genre. Accordingly, output sound from the whole mixer 1 can be easily changed in accordance with the genre, such as rock sound, jazz sound or the like. The collective change of the group preset by the switching of the genre is effective, for example, in the case of changing the output sound from the mixer 1 for each genre of a musical piece.

As described above, according to the invention, even a user unfamiliar with operation of the mixer can extremely easily perform a setup work for a group module constituted by gathering a plurality audio signals into one group, for example, in player-by-player basis or the like. Since a group preset 70 constituted by gathering parameter values for one or a plurality of input channels 100 according to the instrument kind or usage is prepared, the user easily understands correspondence between the group strip 120 and the instrument kind (player) or usage. Further, since the setup is performed in group module-by-group module basis, the user does not need to consider detailed parameter values for each channel module.

Note that though the determination of the input group 110 being the application destination and the securement of the unassigned channels are automatically performed following the predetermined rule at the step S3, the determination of the input group 110 being the application destination and/or the securement of the unassigned channels may be manually performed by the user.

Note that the group display section 82 illustrated in FIG. 9 is configured to display only the input groups 110 to which the group presets are being applied (assigned) at present among all of the input groups 110 included in the mixer 1, but may employ a configuration in which columns of the name 820 and the number of input channels 821 are empty regarding input groups to which any group preset has not been assigned, as another configuration example.

Note that it has been described that when a group preset is selected in the group preset selection section 81, only the input groups 110 to which the identified group preset 70 being the change destination is applicable are displayed in a normal display state and the other input groups 110 are displayed in grayout in the group display section 82. Here, it is also adoptable to make it impossible to select the input groups 110 displayed in grayout as the application destination. More specifically, the group display section 82 may be configured to display the input groups 110 to which the selected group preset 70 is not applicable, in an unselectable display state.

Note that a user may be allowed to edit (change) the existing group preset 70 and store the edit result as a new group preset 70, or to create and store a new group preset 70 by himself/herself.

Note that it is described that the parameters of the input channel 100 are not to be controlled on the console panel in the above embodiment, but the individual input channels 100 may be assigned to the group strips 120 so that values of the parameters may be adjusted in channel-by-channel basis.

Further, the configuration in which the input groups 110 and the group strips 120 correspond in one-to-one basis has been described in the above embodiment, but the invention may be configured to include a larger number of input groups 110 (modules) than the number of group strips 120 provided on the console panel and to switch the input group 110 being the operation target of the group strip 120 by layer switching or the like.

The invention is not limited to be configured and carried out as an invention of the digital audio mixing device but can also be configured and carried out as an invention of a program.

### REFERENCE SIGNS LIST

1 . . . digital audio mixing device (mixer), 100 . . . input channel, 105 and 37 . . . group patch, 110 . . . input group, 120 . . . group strip (group controller), 24 . . . group bus, 60 . . . insertion effector, 61 . . . switch, 70 . . . group preset, 71 . . . input channel parameter set, 72 . . . input group parameter set, 73 . . . assignment information (grouping information), 74 . . . effect information, 75 . . . group attribute information

1. A digital audio mixing device comprising:
a preset memory for storing a plurality of preset data, each of the plurality of the preset data including, as a preset, values of a plurality of parameters used in a signal processing module, each of the plurality of the preset data being corresponded to one kind of musical genre and including, as the preset, the values of the parameters suitable for the corresponded musical genre;
a plurality of signal processing modules to be set up based on values of the plurality of the parameters included in the preset data being corresponded to a musical genre;
a genre selector for selecting another musical genre other than presently selected musical genre according to an operation by a user;
a changing device for changing, in response to the selection of the another musical genre, changing the preset data presently used to set up the signal processing modules to another preset data corresponded to the another musical genre, and setting up the signal processing modules based on values of the plurality of the parameters included in the another preset data.

2. A digital audio mixing device according to claim 1,
wherein each of the plurality of the preset data is corresponded to one kind of instrument, and
the changing device executes the change of preset data in response to the selection of the another musical genre, if both the preset data presently used and the another preset data are corresponded to the same kind of instrument.

3. A digital audio mixing device according to claim 1,
wherein the signal processing modules include a channel module for processing an audio signal and a plurality of group modules, each of the group modules being for processing an audio signal of a group in which one or a plurality of the channel modules are gathered,
each of the plurality of the preset data includes, as the preset, values of a plurality of group parameters used in the group module, and values of a plurality of channel module parameters used in one or a plurality of the channel modules to be grouped to the group module, and
the changing device changes values of parameters used in the group module and values of parameters used in the one or the plurality of the channel modules grouped to the group module, to the values of the group parameters and the values of the channel module parameters included in the another preset data corresponded to the another musical genre.

4. A non-transitory computer readable medium storing program instructions executable to perform a setup processing of a digital audio mixing device,
wherein the digital audio mixing device comprising:
a preset memory for storing a plurality of preset data, each of the plurality of the preset data including, as a preset, values of a plurality of parameters used in a signal processing module, each of the plurality of the preset data being corresponded to one kind of musical genre and including, as the preset, the values of the parameters suitable for the corresponded musical genre; and
a plurality of signal processing modules to be set up based on values of the plurality of the parameters included in the preset data being corresponded to a musical genre, and
wherein the setup processing comprising:
selecting another musical genre other than presently selected musical genre according to an operation by a user; and
changing, in response to the selection of the another musical genre, changing the preset data presently used to set up the signal processing modules to another preset data corresponded to the another musical genre, and setting up the signal processing modules based on values of the plurality of the parameters included in the another preset data.

5. A digital audio mixing device comprising:
a plurality of channel modules, each of the channel modules being for processing an audio signal;
a plurality of group modules, each of the group modules being for processing an audio signal of a group in which one or a plurality of the channel modules are gathered;
a plurality of group controllers, each of the group controllers corresponding to the group module and comprising plurality of controls for controlling the processing in the corresponding group module;
a group preset memory for storing a plurality of group presets, each of the group presets including, as preset data, a channel module parameter value to be used in one or a plurality of the channel modules, a group module parameter value to be used in one of the group modules, and a grouping information for grouping the one or the plurality of the channel modules into the one group module;
a group preset selector for selecting one of the group presets according to an operation by a user; and
an application device for applying the selected group preset to one of the group modules, the application device setting up each of one or a plurality of the channel modules to be grouped based on the channel module parameter value of the selected group preset, setting up the one group module based on the group module parameter value of the selected group preset, and grouping the one or the plurality of the channel modules into the one group module.

6. A non-transitory computer readable medium storing program instructions executable to perform a setup processing of a digital audio mixing device,
wherein the digital audio mixing device comprising:
a plurality of channel modules, each of the channel modules being for processing an audio signal;
a plurality of group modules, each of the group modules being for processing an audio signal of a group in which one or a plurality of the channel modules are gathered;
a plurality of group controllers, each of the group controllers corresponding to the group module and comprising plurality of controls for controlling the processing in the corresponding group module; and
a group preset memory for storing a plurality of group presets, each of the group presets including, as preset data, a channel module parameter value to be used in one or a plurality of the channel modules, a group module parameter value to be used in one of the group modules, and a grouping information for grouping the one or the plurality of the channel modules into the one group module, and
wherein the setup processing comprising:
selecting one of the group presets according to an operation by a user; and
applying the selected group preset to one of the group modules, the applying including setting up each of one or a plurality of the channel modules to be grouped based on the channel module parameter value of the selected group preset, setting up the one group module based on the group module parameter value of the selected group preset, and grouping the one or the plurality of the channel modules into the one group module.
